(19) United States
(12) Patent Application Publication
(10) Pub. No.: US 2025/0026378 A1
(43) Pub. Date: Jan. 23, 2025

(54) HYBRID ARTIFICIAL INTELLIGENCE AGENT BEHAVIOR GENERATION SYSTEM FOR AUTONOMOUS DRIVING SIMULATION

(71) Applicant: TuSimple, Inc., SAN DIEGO, CA (US)

(72) Inventors: Junfeng SHE, San Diego, CA (US); Dantong DONG, San Diego, CA (US); Yixin YANG, San Diego, CA (US)

(21) Appl. No.: 18/776,023

(22) Filed: Jul. 17, 2024

Related U.S. Application Data
(60) Provisional application No. 63/514,622, filed on Jul. 20, 2023.

(51) Int. Cl. B60W 60/00; B60W 30/095; G06N 20/00

(52) U.S. Cl. CPC B60W 60/0027; B60W 30/0956; G06N 20/00

(57) ABSTRACT

Devices, systems, and methods for trajectory generation for controlling an autonomous vehicle are described. In an embodiment, a trajectory generation system includes a behavior generator including a plurality of states of an object to generate one of the plurality of states, each of the plurality of states of the object corresponding to a behavior of the object at a given time, an artificial intelligence information generator including one or more first parameters for determining a trajectory of the object, a user defined information generator including one or more second parameters for determining a variant trajectory of the object, and a simulator configured to generate a future position of the object by performing a computation operation on the one of the plurality of states using a combination of the one or more first parameters and the one or more second parameters.

### CROSS-REFERENCE TO RELATED APPLICATIONS

This document claims priority to and the benefit of U.S. Provisional Application No. 63/514,622, filed on Jul. 20, 2023. The aforementioned application of which is incorporated herein by reference in its entirety.

### TECHNICAL FIELD

This document generally relates to autonomous driving simulation systems and methods.

### BACKGROUND

Autonomous driving simulation is a technology for testing the features and functionalities of autonomous driving systems based on data collected in real life. For example, autonomous vehicles and other moving vehicles may use driving simulations to test and improve passenger safety, vehicle decision-making, sensor data analysis, and route optimization. However, the data collected in real life does not accurately reflect real-world scenarios that are difficult to test in the real world due to safety concerns.

### SUMMARY

Disclosed are devices, systems, and methods for trajectory generation for controlling an autonomous vehicle.

In an aspect, a trajectory generation system for controlling an autonomous vehicle includes a behavior generator including a plurality of states of an object relative to the autonomous vehicle, each of the plurality of states of the object corresponding to a behavior of the object at a given time, the behavior generator configured to generate one of the plurality of states, an artificial intelligence information generator including one or more first parameters for determining a trajectory of the object and in communication with the behavior generator to obtain the one of the plurality of states from the behavior generator and to provide the one or more first parameters based on the one of the plurality of states, a user defined information generator including one or more second parameters for determining a variant trajectory of the object and in communication with the behavior generator to obtain the one of the plurality of states from the behavior generator and to provide the one or more second parameters based on the one of the plurality of states, and a simulator in communication with the artificial intelligence information generator and the user defined information generator and configured to generate a future position of the object by performing a computation operation on the one of the plurality of states using a combination of the one or more first parameters or the one or more second parameters.

In another aspect, a trajectory generation method for controlling an autonomous vehicle includes training, using a simulation platform, a first machine learning (ML) algorithm configured to control operation of an autonomous vehicle based on interaction with a simulated vehicle object and a simulated environmental condition in which the autonomous vehicle is operating, wherein operation of the vehicle object is controlled by a combination of a second ML algorithm and an input from a human user and wherein the simulated environmental condition is partly user-controlled.

In another aspect, a trajectory generation method for controlling an autonomous vehicle includes generating a state of an object relative to the autonomous vehicle, out of a plurality of states, each of the plurality of states corresponding to a behavior of the object at a given time, applying the state of the object to an artificial intelligence information generator including one or more first parameters for determining a trajectory of the object and a user defined information generator including one or more second parameters for determining a variant trajectory of the object, and generating a future position of the object relative to the autonomous vehicle by performing a computation operation on the state of the object using a combination of the one or more first parameters and the one or more second parameters.

The above and other aspects and features of the disclosed technology are described in greater detail in the drawings, the description and the claims.

### BRIEF DESCRIPTION OF THE DRAWINGS

FIG. 1 shows a block diagram of an example vehicle ecosystem including an in-vehicle control computer.

FIG. 2A shows an example of simulated artificial intelligence (AI) agent system implemented based on some embodiments of the disclosed technology. FIG. 2B shows an example of behavior system implemented based on some embodiments of the disclosed technology. FIG. 2C shows an example of trajectory system implemented based on some embodiments of the disclosed technology.

FIG. 3 shows another example of AI agent behavior generation system based on some embodiments of the disclosed technology.

FIG. 4 shows another example of AI agent behavior generation system based on some embodiments of the disclosed technology.

FIG. 5 shows a flowchart of an example of a trajectory generation method for controlling an autonomous vehicle based on some embodiments of the disclosed technology.

FIG. 6 shows a flowchart of another example of a trajectory generation method for controlling an autonomous vehicle based on some embodiments of the disclosed technology.

### DETAILED DESCRIPTION

The transportation industry has been undergoing considerable changes in the way technology is used to control the operation of the vehicles. As exemplified in the automotive passenger vehicle, there has been a general advancement towards shifting more of the operational and navigational decision making away from the human driving and into on-board computing power. This is exemplified in the extreme by the numerous under-development autonomous vehicles. Current implementations are in intermediate stages, such as the partially-autonomous operation in some vehicles (e.g., autonomous acceleration and navigation, but with the requirement of a present and attentive driver), the safety-protecting operation of some vehicles (e.g., maintaining a safe following distance and automatic braking), the safety-protecting warnings of some vehicles (e.g., blind-spot indicators in side-view mirrors and proximity sensors), as well as ease-of-use operations (e.g., autonomous parallel parking).

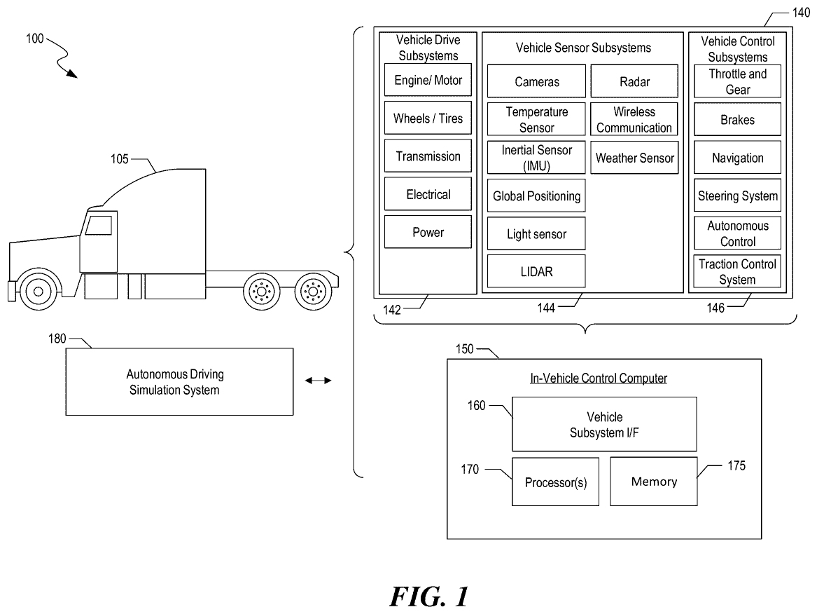

FIG. 1 shows a block diagram of an example vehicle ecosystem 100 in which an in-vehicle control computer 150 located in an autonomous vehicle 105. As shown in FIG. 1, the autonomous vehicle 105 may be a semi-trailer truck. The vehicle ecosystem 100 may include several systems and components that can generate and/or deliver one or more sources of information/data and related services to the in-vehicle control computer 150 that may be located in an autonomous vehicle 105. The in-vehicle control computer 150 can be in data communication with a plurality of vehicle subsystems 140, all of which can be resident in the autonomous vehicle 105. The in-vehicle control computer 150 and the plurality of vehicle subsystems 140 can be referred to as autonomous driving system (ADS). A vehicle subsystem interface 160 is provided to facilitate data communication between the in-vehicle control computer 150 and the plurality of vehicle subsystems 140. In some embodiments, the vehicle subsystem interface 160 can include a controller area network controller to communicate with devices in the vehicle subsystems 140.

In some implementations, the in-vehicle control computer 150 may include at least one processor 170 (which can include at least one microprocessor) that executes processing instructions stored in a non-transitory computer readable medium, such as a memory 175. The in-vehicle control computer 150 may also represent a plurality of computing devices that may serve to control individual components or subsystems of the autonomous vehicle 105 in a distributed fashion. In some embodiments, the memory 175 may contain processing instructions (e.g., program logic) executable by the processor 170 to perform various methods and/or functions of the autonomous vehicle 105 as explained in this patent document. For instance, the processor 170 executes the operations associated with the plurality of vehicle subsystems 140 for ensuring safe operation of the autonomous vehicle by training using simulations of different scenarios.

In some implementations, the memory 175 may contain additional instructions as well, including instructions to transmit data to, receive data from, interact with, or control one or more of a vehicle drive subsystem 142, a vehicle sensor subsystem 144, and a vehicle control subsystem 146.

The autonomous vehicle 105 may include various vehicle subsystems that facilitate the operation of vehicle 105. The vehicle subsystems may include the vehicle drive subsystem 142, the vehicle sensor subsystem 144, and/or the vehicle control subsystem 146. The components or devices of the vehicle drive subsystem 142, the vehicle sensor subsystem 144, and the vehicle control subsystem 146 are shown as examples. In some embodiment, additional components or devices can be added to the various subsystems or one or more components or devices can be removed. The vehicle drive subsystem 142 may include components operable to provide powered motion for the autonomous vehicle 105. In an example embodiment, the vehicle drive subsystem 142 may include an engine or motor, wheels/tires, a transmission, an electrical subsystem, and a power source.

The vehicle sensor subsystem 144 may include a number of sensors configured to sense information about an environment in which the autonomous vehicle 105 is operating or a condition of the autonomous vehicle 105. The vehicle sensor subsystem 144 may include one or more cameras or image capture devices, one or more temperature sensors, an inertial measurement unit (IMU), a localization system such as a Global Positioning System (GPS), a laser range finder/LiDAR unit, a RADAR unit, an ultrasonic sensor, and/or a wireless communication unit (e.g., a cellular communication transceiver). The vehicle sensor subsystem 144 may also include sensors configured to monitor internal systems of the autonomous vehicle 105 (e.g., an 02 monitor, a fuel gauge, an engine oil temperature, etc.). In some implementations, the autonomous vehicle 105 may further include a synchronization unit that synchronizes multiple heterogeneous sensors.

The IMU may include any combination of sensors (e.g., accelerometers and gyroscopes) configured to sense position and orientation changes of the autonomous vehicle 105 based on inertial acceleration. The localization system may be any sensor configured to estimate a geographic location of the autonomous vehicle 105. For this purpose, the localization system may include a receiver/transmitter operable to provide information regarding the position of the autonomous vehicle 105 with respect to the Earth. The RADAR unit may represent a system that utilizes radio signals to sense objects within the environment in which the autonomous vehicle 105 is operating. In some embodiments, in addition to sensing the objects, the RADAR unit may additionally be configured to sense the speed and the heading of the objects proximate to the autonomous vehicle 105. The laser range finder or LiDAR unit may be any sensor configured to sense objects in the environment in which the autonomous vehicle 105 is located using lasers. The LiDAR unit may be a spinning LiDAR unit or a solid-state LiDAR unit. The cameras may include one or more cameras configured to capture a plurality of images of the environment of the autonomous vehicle 105. The cameras may be still image cameras or motion video cameras.

The vehicle control subsystem 146 may be configured to control operation of the autonomous vehicle 105 and its components. Accordingly, the vehicle control subsystem 146 may include various elements such as a throttle and gear, a brake unit, a navigation unit, a steering system and/or an autonomous control unit. The throttle may be configured to control, for instance, the operating speed of the engine and, in turn, control the speed of the autonomous vehicle 105. The gear may be configured to control the gear selection of the transmission. The brake unit can include any combination of mechanisms configured to decelerate the autonomous vehicle 105. The brake unit can use friction to slow the wheels in a standard manner. The brake unit may include an anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically while the autonomous vehicle 105 is in operation. In some embodiments, the navigation unit may be configured to incorporate data from the localization system and one or more predetermined maps so as to determine the driving path for the autonomous vehicle 105. The steering system may represent any combination of mechanisms that may be operable to adjust the heading of vehicle 105 in an autonomous mode or in a driver-controlled mode.

The traction control system (TCS) may represent a control system configured to prevent the autonomous vehicle 105 from swerving or losing control while on the road. For example, TCS may obtain signals from the IMU and the engine torque value to determine whether it should intervene and send instruction to one or more brakes on the autonomous vehicle 105 to mitigate the autonomous vehicle 105 swerving. TCS is an active vehicle safety feature designed to help vehicles make effective use of traction available on the road, for example, when accelerating on low-friction road surfaces. When a vehicle without TCS attempts to accelerate on a slippery surface like ice, snow, or loose gravel, the wheels can slip and can cause a dangerous driving situation. TCS may also be referred to as electronic stability control (ESC) system.

In some embodiments of the disclosed technology, an autonomous driving simulation system can be used for training and validation of an autonomous driving system, such as the vehicle drive subsystem 142 and the vehicle control subsystem 146. In one example, the autonomous driving simulation system can collect real-life traffic patterns and driver/pedestrian behaviors to use the collected information in the training and validation of the autonomous driving system. However, such real-life information collected by actual vehicles and the autonomous driving simulation system may not fully reflect unrealistic and/or dangerous driver/pedestrian behaviors because such behaviors are very rare in real world.

In order to fully reflect such unrealistic and/or dangerous driver/pedestrian behaviors, the disclosed technology can be implemented in some embodiments to provide an autonomous driving simulation system 180 that can allow users to control all aspects related to the simulation, including traffic patterns and driver/pedestrian behaviors.

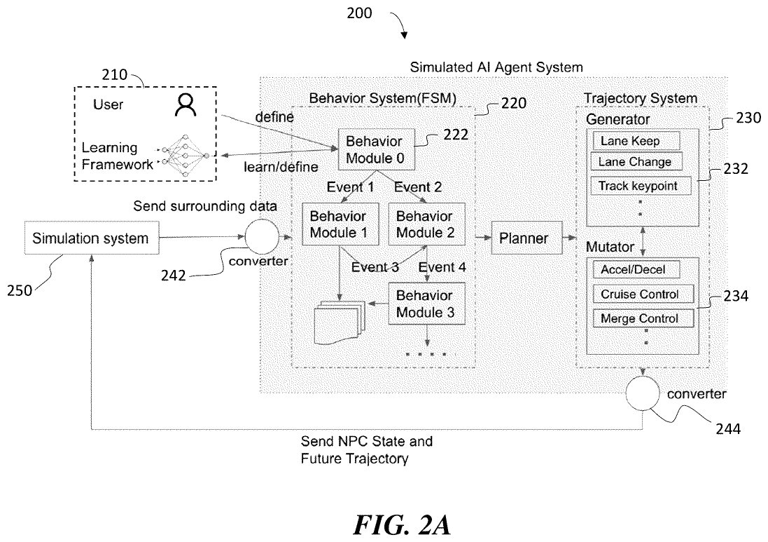

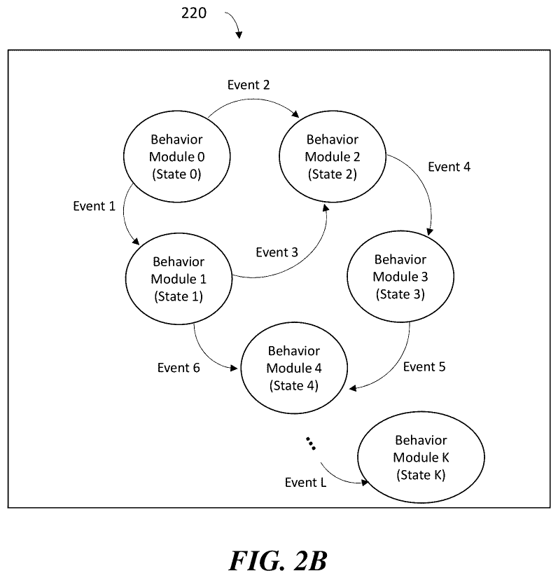

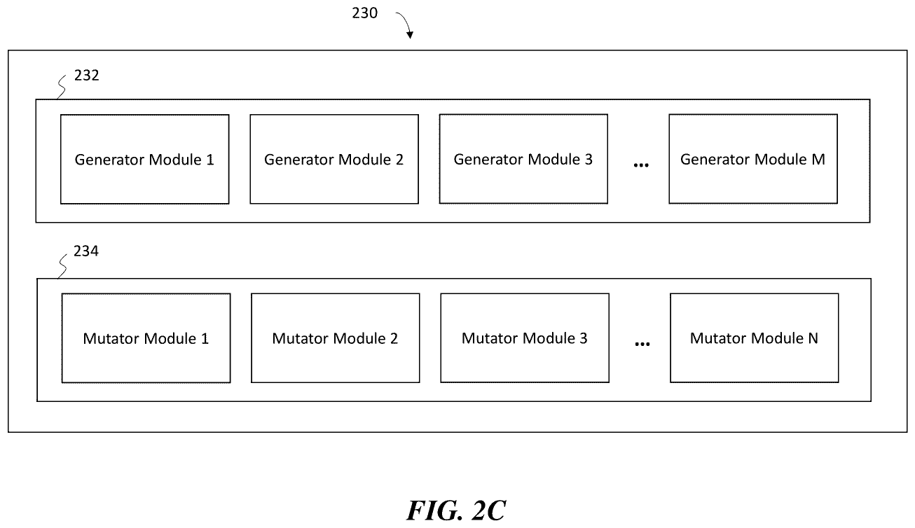

In some embodiments of the disclosed technology, an artificial intelligence (AI) agent system (e.g., 180 in FIG. 1 or 200 in FIG. 2A) allows the creation of external vehicles/objects/pedestrians with desired behaviors to generate simulation scenarios that are used to test autonomous vehicles and their vehicle drive subsystems and vehicle control subsystems.

In some embodiments of the disclosed technology, the desired behaviors of external vehicles/objects/pedestrians that can generated by the AI agent system include one or more of: dynamically decelerating/accelerating toward target speed; cruise control with front car with specific time gap; collision avoidance within defined parameters; tracking defined trajectory with realistic car kinematics; reaction with specified perception range; lane keeping with specific offset with respect to center, left, or right; negotiating merging and lane changing/lane keeping/cutting in; swerving/turning with specific parameter; or switching/changing behavior dynamically according to surroundings.

The disclosed technology can be implemented in some embodiments to generate simulated AI agent behavior without limitation, e.g., traffic/vehicle/object/pedestrian behaviors that can be seen and unseen in real life. Notably, the AI agent system implemented based on some embodiments of the disclosed technology can mimic and integrate the real-life behavior by acting as a machine learning framework and by learning from gathered data. This hybrid approach is superior to purely learning or rule-based models in the sense that it has better reproducibility and complexity in different types of behavior generation.

In some implementations, the AI agent system can use a user defined trajectory based on lane or key point, interactive event trigger, and a learning-based trajectory that can be integrated with any general learning framework.

Some implementations that can realistically simulate the behavior of external vehicles/objects/pedestrians focus on a simulation through learning approach, but there is a void of high-quality data gathered on external objects behavior, and some behaviors can be unrealistic/dangerous to gather in real life, although they are crucial in offline evaluation components such as simulation. For example, in an accident scenario, since it is impossible or dangerous to gather data from real life events, purely learning based behavior models may not fully simulate accident/crashing agent behavior. In order to address this issue, the disclosed technology can be implemented in some embodiments to provide an artificial intelligence (AI) agent behavior generation system that allows the creation of specific behavior/trajectory that can be used along with data gathered in real-life situations to test any autonomous driving system. Furthermore, the AI agent behavior generation system can generate a trajectory with the same format as the data gathered in real-life situations, so that the system-generated trajectory can also be fed back into the AI agent system to train/learn a specific behavior pattern, using both the real-life data and the system-generated data including, e.g., accident data.

FIG. 2A shows an example of simulated artificial intelligence (AI) agent system implemented based on some embodiments of the disclosed technology. FIG. 2B shows an example of behavior system implemented based on some embodiments of the disclosed technology. FIG. 2C shows an example of trajectory system implemented based on some embodiments of the disclosed technology.

Referring to FIG. 2A, in some implementations, a simulated AI agent system 200 may include a behavior system 220 and a trajectory system 230. In some implementations, the behavior system 220 may be a finite state machine (FSM) that can be in one of a plurality of states at a given time. In some implementations, the behavior system 220 may include a plurality of behavior modules each of which indicates an external vehicle/object/pedestrian behavior and may transition between different behavior modules upon occurrence a certain event. For example, either a learning framework or a user (210) provides a predefined behavior or a learned behavior to the behavior system 220, and the behavior system 220 is configured to: transition from behavior module 0 to behavior module 1 upon occurrence of event 1; transition from behavior module 0 to behavior module 2 upon occurrence of event 2; transition from behavior module 2 to behavior module 3 upon occurrence of event 3; and transition from behavior module 2 to behavior module 3 upon occurrence of event 4. In some implementations, each behavior module can be used to indicate the external vehicles/objects/pedestrian behavior. In one example, the behavior module 0 can be used to indicate a default behavior state of the external vehicle, object, or pedestrian, and the other behavior modules (behavior modules 1, 2, 3, 4 . . . , N) can be used to indicate a plurality of behaviors that can result from a previous behavior module upon occurrence of a certain event. In some implementations, Nₜₕ behavior module can produce a final behavior state of the external vehicle, object, or pedestrian.

In some implementations, the behavior module 0 may correspond to an initial state of a non-player character (NPC) (e.g., external vehicle/object/pedestrian). In one example, the behavior modules 1, 2, 3, 4 . . . , N correspond to different states of the NPC, respectively, and are determined using a machine learning framework based on realistic behaviors of the NPC that can be observed. In one example, the behavior modules 0, 1, 2, 3, 4 . . . , N correspond to behaviors of the NPC (e.g., external vehicle/object/pedestrian) that the machine learning framework expects to occur upon an occurrence of an event. In some implementations, the behavior system 220 including the behavior modules 0, 1, 2, 3, 4 . . . , N provides a state of the NPC to the trajectory system 230.

In some implementations, the trajectory system 230 may include a generator 232 and a mutator 234 configured to generate parameters for generating a trajectory of an NPC (e.g., an external vehicle/object/pedestrian behavior). In some implementations, the trajectory system 230 may include a simulation system 250 configured to generate a future position of the NPC based on the parameters provided by the generator 232 and the mutator 234.

In some implementations, the generator 232 may include first parameters corresponding to realistic trajectories and the mutator 234 may include second parameters corresponding to unrealistic trajectories.

In some implementations, the first parameters may be used to simulate realistic behaviors/trajectories of the NPC (e.g., external vehicle/object/pedestrian) as expected by the machine learning framework because the realistic behaviors/trajectories can be observed in real-world scenarios. In some implementations, the second parameters may be used to simulate unrealistic behaviors/trajectories of the NPC (e.g., external vehicle/object/pedestrian) that may not be expected by the machine learning framework because the simulate unrealistic behaviors/trajectories are hardly observed in real-world scenarios. In one example, the unrealistic behaviors of the NPC (e.g., external vehicle/object/pedestrian) may be provided by a user input.

The disclosed technology can be implemented in some embodiments to provide traffic-based simulation methods and systems. In addition, the disclosed technology can be implemented in some embodiments to integrate the traffic-based simulation with high-definition maps to generate desired agent behavior even in a complete void of real-life data.

The disclosed technology can be implemented in some embodiments to provide strong controllability with reactive realism. Some example implementations focus on realism through learning approach, but pure learning approach has its limitation such as low controllability and requires high volume data which is not vastly available. The system implemented in some embodiments can provide a strong controllability through a heuristic-based simulation system with a learning framework to achieve reactive realism through behavior cloning.

The disclosed technology can be implemented in some embodiments to provide a modeling of a non-player character (NPC) driving intention (e.g., intention of an external driver) and a trajectory generation for an autonomous driving system. Behavior templates has the ability to model the intention of a driver via a gaming-based AI module or a learning-based AI module, and a trajectory generation system is specifically designed for autonomous driving simulation to generate a fine-tuned trajectory according to the high-level intention or reaction to events.

The disclosed technology can be implemented in some embodiments to provide a template intention modeling with a finite state machine (FSM) for transition to model the behavior of NPC more dynamically based on a runtime context and environment. This approach has a great balance between controllability and realism.

The disclosed technology can be implemented in some embodiments to provide a system including a heuristic-based module along with FSM that allows user to recreate realistic NPC behaviors that are observed and unrealistic NPC behaviors that are not observed, so that all the possible scenarios including accident or crash scenarios can be defined through the system.

The disclosed technology can be implemented in some embodiments to provide a context encoder/map rasterizer that is compatible with a custom defined data bag and map and other collected traffic data for learning purpose.

The disclosed technology can be implemented in some embodiments to configure a heuristic simulated agent that uses distribution variances for creating variance scenarios based on models of parameters, initially for NPC behaviors.

In some implementations, the term “NPC behavior” may be used to indicate external vehicles/objects/pedestrian behaviors. For example, the system implemented in some embodiments can create a normal distribution used for an NPC speed, and a variance to sample this normal distribution and run a series of scenarios with different speed values along this distribution.

The system based on some embodiments of the disclosed technology may create an NPC with AI mode and select a behavior generator file out of a plurality of behavior generator files. In one example, the system may include a list of parameters associated with the selected behavior generator such that values of the parameters are associated with a certain distribution. The system based on some embodiments of the disclosed technology may also create a distribution object. In one example, the system can select a normal distribution that includes a mean and standard deviation. In one example, default sample values are used to define the normal distribution when variances are not used.

In some embodiments of the disclosed technology, the plurality of behavior generator files can be created based on data gathered from real life events. In one example, each behavior generator file may include a default behavior state and a behavior list including a plurality of behaviors with behavior conditions, behavior transitions, and a final transition state.

In some embodiments of the disclosed technology, variances can be used to define a range of sample values beyond the sample values determined based on data gathered from real life events.

Referring to FIG. 2B, in some implementations, the behavior system 220 may include a finite state machine (FSM). In one example, the FSM may include a plurality of states State 0, State 1, State 2, State 3, State 4, . . . , State K, where K is a positive integer. In one example, each state corresponds to an NPC behavior (e.g., an external vehicle/object/pedestrian behavior), which may transition between different states State 0, State 1, State 2, State 3, State 4, . . . , State K upon occurrence an event Event 1, Event 2, Event 3, Event 4, Event 5, Event 6, . . . , Event L, where L is a positive integer.

Referring to FIG. 2C, in some implementations, the trajectory system 230 may include a generator 232 and a mutator 234 configured to generate parameters for generating a trajectory of an NPC (e.g., an external vehicle/object/pedestrian behavior). In some implementations, the generator 232 may include a plurality of generator modules Generator Module 1, Generator Module 2, Generator Module 3, . . . , Generator Module M, where M is a positive integer. In some implementations, the mutator 234 may include a plurality of mutator modules Mutator Module 1, Mutator Module 2, Mutator Module 3, . . . , Mutator Module N, where N is a positive integer. In some implementations, each of the plurality of generator modules Generator Module 1, Generator Module 2, Generator Module 3, . . . , Generator Module M may include one or more first parameters corresponding to realistic trajectories, and each of the plurality of mutator modules Mutator Module 1, Mutator Module 2, Mutator Module 3, . . . Mutator Module N may include one or more second parameters corresponding to unrealistic trajectories.

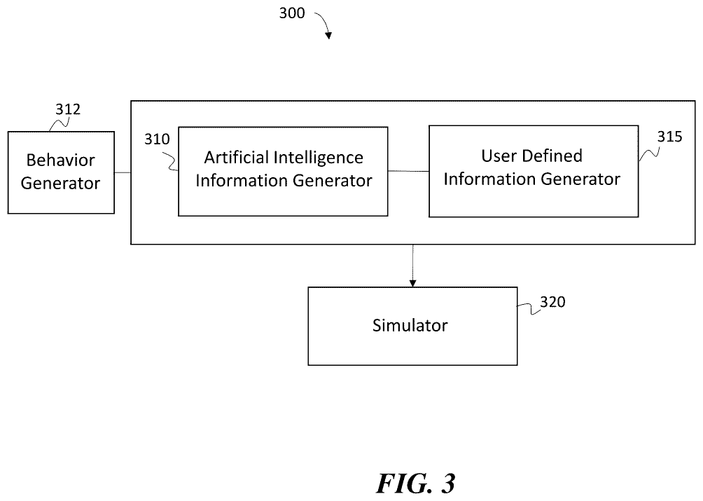

FIG. 3 shows an example of AI agent behavior generation system based on some embodiments of the disclosed technology.

In some embodiments of the disclosed technology, an AI agent behavior generation system 300 may include an artificial intelligence information generator 310, a simulator 320, and a user defined information generator 315.

In some embodiments of the disclosed technology, the artificial intelligence information generator 310 is in communication with a behavior generator 312 to obtain a normal distribution of an NPC (e.g., external vehicle/object/pedestrian). In one example, the artificial intelligence information generator 310 may include an artificial intelligence (AI) system configured to provide realistic behaviors of the NPC using an AI learning system.

In some embodiments of the disclosed technology, the user defined information generator 315 may provide second parameters that can be used in the simulator 320 to generate unrealistic behaviors of the NPC (e.g., external vehicle, object, or pedestrian) according to the second parameters. In this way, the user defined information generator 315 creates specific behaviors/trajectories that can be used along with behaviors/trajectories that are generated using the artificial intelligence information generator 310.

In some embodiments of the disclosed technology, the simulator 320 may generate a behavior of an NPC (e.g., external vehicle/object/pedestrian) based on one or more parameters provided by the artificial intelligence information generator 310 or based on one or more second parameters provided by the user defined information generator 315.

In some embodiments of the disclosed technology, the behavior generator 312 includes a plurality of states at a given time. In some implementations, each of the plurality of states corresponds to a certain behavior of an NPC (e.g., an external vehicle/object/pedestrian). In one example, the plurality of states includes a default behavior state corresponding to an initial state of the NPC. In one example, the plurality of states corresponds to a plurality of behaviors with behavior conditions and actions that can trigger a transition to a certain behavior. In one example, the behavior conditions can be used to define how a transition can be triggered, and the actions can trigger a transition to a certain behavior. In one example, the behavior generator 312 includes a final state of an NPC after it finishes all the transitions.

In some implementations, the behavior conditions may include an acceleration of an NPC vehicle. In one example, the acceleration of the NPC vehicle may be compared to a certain value to determine whether the acceleration of the NPC vehicle satisfies an acceleration condition.

In some implementations, the behavior conditions may include a boundary distance between an NPC vehicle and a boundary of a lane in which the NPC vehicle is moving. For example, the distance may include a first distance between the NPC vehicle and the left line of the lane and a second distance between the NPC vehicle and the right line of the lane. The boundary distance can be compared to a certain value to determine whether the distance between the NPC vehicle and the right/left line of the lane satisfies a boundary distance condition.

In some implementations, the behavior conditions may include car lights such as taillights for indicating right or left turn, brake, or emergency, and headlight flashing.

In some implementations, the behavior conditions may include a distance between an NPC vehicle and a certain point. In one example, the distance between the NPC vehicle and the certain point can be compared to a certain value to determine whether the distance satisfies a distance condition.

In some implementations, the behavior conditions may include a distance between different NPC vehicles. In one example, the distance between the NPC vehicle and the certain point can be compared to a certain value to determine whether the distance satisfies a distance condition.

In some implementations, the behavior conditions may include a region condition as to whether an NPC vehicle is inside a certain region. In one example, the region condition is satisfied when at least part of the NPC vehicle is inside the certain region. In another example, the region condition is satisfied when the whole NPC vehicle is inside the certain region.

In some implementations, the behavior conditions may include an absolute speed of an NPC vehicle. In one example, a speed of the NPC vehicle can be compared to a certain speed value to determine whether the absolute speed of the NPC vehicle satisfies an absolute speed condition.

In some implementations, the behavior conditions may include a relative speed of an NPC vehicle. In one example, a speed of the NPC vehicle can be compared to a speed of another vehicle to determine whether the relative speed of the NPC vehicle satisfies a relative speed condition.

In some embodiments of the disclosed technology, the artificial intelligence information generator 310 may include an AI learning system to generate a behavior of an NPC that react to its surrounding environment using the AI learning system. In one example, the behavior of the NPC may include avoiding collision through adaptive cruise control and lane-keeping.

In some implementations, the behavior of the NPC that react to its surrounding environment may include accelerating/decelerating to maintain a safe longitudinal distance between the NPC and front vehicles to avoid collision, hard brakes to avoid collision in emergency situations; hard braking when an autonomous vehicle (EGO) is behind the NPC, lane changing based on another vehicle's lane change, and accelerating/decelerating under merging conditions on a ramp or a main road.

In some implementations, the artificial intelligence information generator 310 may include one or more parameters to determine the behavior of the NPC using the AI learning system. In some implementations, the one or more parameters include a target speed of the NPC. Here, the target speed of the NPC may indicate a certain speed limit of the NPC traveling within a lane. In order for the artificial intelligence information generator 310 to generate a behavior of the NPC, the NPC must not exceed the target speed.

In some implementations, the one or more parameters include a time gap distance parameter corresponding to a time distance between the NPC and a front vehicle traveling in front of the NPC. If the time gap distance is equal to or smaller than a desired time gap distance, NPC decelerates to a speed based on the speed of the front vehicle and the difference between the current time gap distance and the desired time gap distance. If the time gap distance is greater than the desired time gap distance, and the current speed of the NPC is smaller than a target speed, then NPC accelerates (e.g., at a predefined rate that is defined for a normal acceleration) until it reaches a target speed. The deceleration and acceleration can be determined using the AI learning system.

In some implementations, the one or more parameters include a normal acceleration parameter corresponding to a normal acceleration of an NPC. In one example, the normal acceleration indicates the rate at which the NPC accelerates within a desired range. In some implementations, the one or more parameters include a normal deceleration of an NPC. In one example, the normal deceleration indicates the rate at which the NPC decelerates within a desired range. In some implementations, when the NPC is not hard braking, the NPC applies the normal acceleration or the normal deceleration to maintain its speed within the desired range using the AI learning system.

In some implementations, the one or more parameters include a parameter associated with emergency longitudinal distance/emergency deceleration. In one example, when at least part of another vehicle enters a specified area in front of an NPC that is defined as an emergency longitudinal distance, the NPC immediately applies an emergency deceleration to avoid collision using the AI learning system. In one example, the NPC decelerates at a constant emergency deceleration rate using the AI learning system.

In some implementations, the one or more parameters include a merging parameter so that an NPC accelerates or decelerates under merging conditions using the AI learning system. In some implementations, the one or more parameters include a lane combining parameter so that an NPC accelerates or decelerates under lane combining conditions using the AI learning system.

In some implementations, the one or more parameters include a hard brake parameter corresponding to emergency situations such as hard braking of an NPC traveling in front of an autonomous vehicle (EGO). The hard braking of the NPC causes the EGO to hard brake to avoid collision using the AI learning system. In some implementations, when any part of the EGO is within a distance range between an NPC traveling in front of the EGO, the hard brake parameter triggers a hard brake deceleration to be performed by the EGO.

In some embodiments of the disclosed technology, the user defined information generator 315 may provide one or more second parameters to allow an NPC to travel through a user defined trajectory.

In some implementations, the user defined information generator 315 may allow the simulator 320 to generate an unrealistic or variant behavior that is different from an AI expected behavior generated using the AI learning system based on the parameters in the artificial intelligence information generator 310.

In some implementations, the user defined information generator 315 may include one or more second parameters to determine an unrealistic behavior of the NPC based on the user defined trajectory.

In some implementations, the one or more second parameters include a variant time gap distance parameter corresponding to a time distance between the NPC and a front vehicle traveling in front of the NPC. If the variant time gap distance is equal to or smaller than a desired time gap distance, NPC decelerates to a speed based on the speed of the front vehicle and the difference between the current time gap distance and the desired time gap distance. If the variant time gap distance is greater than the desired time gap distance, and the current speed of the NPC is smaller than a target speed, then NPC accelerates (e.g., at a predefined rate that is defined for a normal acceleration) until it reaches a target speed. The deceleration and acceleration can be determined based on the user defined trajectory.

In some implementations, the one or more second parameters include a variant acceleration parameter corresponding to a variant acceleration of an NPC. In one example, the variant acceleration indicates the rate at which the NPC accelerates within a desired range based on the user defined trajectory. In some implementations, the one or more second parameters include a variant deceleration of an NPC. In one example, the variant deceleration indicates the rate at which the NPC decelerates within a desired range based on the user defined trajectory. In some implementations, when the NPC is not hard braking, the NPC applies the variant acceleration or the variant deceleration to maintain its speed within the desired range based on the user defined trajectory.

In some implementations, the one or more second parameters include a parameter associated with emergency longitudinal distance/emergency deceleration. In one example, when at least part of another vehicle enters a specified area in front of an NPC that is defined as an emergency longitudinal distance, the NPC immediately applies an emergency deceleration to avoid collision based on the user defined trajectory. In one example, the NPC decelerates at a constant emergency deceleration rate based on the user defined trajectory.

In some implementations, the one or more second parameters include a variant merging parameter so that an NPC accelerates or decelerates under merging conditions based on the user defined trajectory. In some implementations, the one or more parameters include a lane combining parameter so that an NPC accelerates or decelerates under lane combining conditions based on the user defined trajectory.

In some implementations, the one or more second parameters include a variant hard brake parameter corresponding to hard braking for avoiding collision in emergency situations based on the user defined trajectory.

In some implementations, the one or more second parameters include a transition trigger parameter to determine whether the simulator 320 uses the artificial intelligence information generator 310 or the user defined information generator 315. In one example, the simulator 320 may generate a behavior of an NPC using the user defined information generator 315 by switching from the artificial intelligence information generator 310 to the user defined information generator 315 based on the transition trigger parameter. In one example, the simulator 320 may generate a behavior of an NPC using the artificial intelligence information generator 310 by switching from the user defined information generator 315 to the artificial intelligence information generator 310 based on the transition trigger parameter.

In some implementations, the one or more second parameters include a merge parameter to determine a behavior (e.g., pre-merge speed, acceleration, deceleration) of an NPC when another incoming vehicle arrives at a merging point in front of the NPC based on the user defined trajectory.

In some implementations, the one or more second parameters include a swerving parameter to determine a swerving behavior of an NPC in response to a behavior of another vehicle near the NPC based on the user defined trajectory. In one example, the swerving parameter includes a pivot ratio to control a swerving angle and a lateral gap to specify the final position after swerving. In one example, for every 1 meter traveled longitudinally, the NPC swerves x meter laterally according to the pivot ratio. In one example, the lateral gap indicates a lateral distance to keep away from the closest vehicles in the lateral axis of the NPC.

When a vehicle is present inside an area, the NPC executes a swerve operation at an angle determined based on the pivot ratio until the NPC reaches the final position determined based on the lateral gap.

In some implementations, the behavior transitions include lane change, acceleration, lane keeping, and swerving. In one example, a behavior transition corresponding to the lane change may be triggered when a predetermined portion of an NPC vehicle has crossed a line between different lanes. In one example, the acceleration may be triggered when the NPC vehicle has reached a predetermined speed. In one example, the lane keeping may be triggered when the NPC vehicle stays within a lane for a predetermined period of time. In one example, the swerving may be triggered when the NPC vehicle changes the direction in which it is moving. Here, whether the NPC vehicle has changed its direction can be determined based on whether a distance between the NPC vehicle and a different vehicle has changed.

In some implementations, the simulator 320 may simulate NPC behaviors and generate a trajectory of the NPC based on trajectory information provided by the artificial intelligence information generator 310 or the user defined information generator 315.

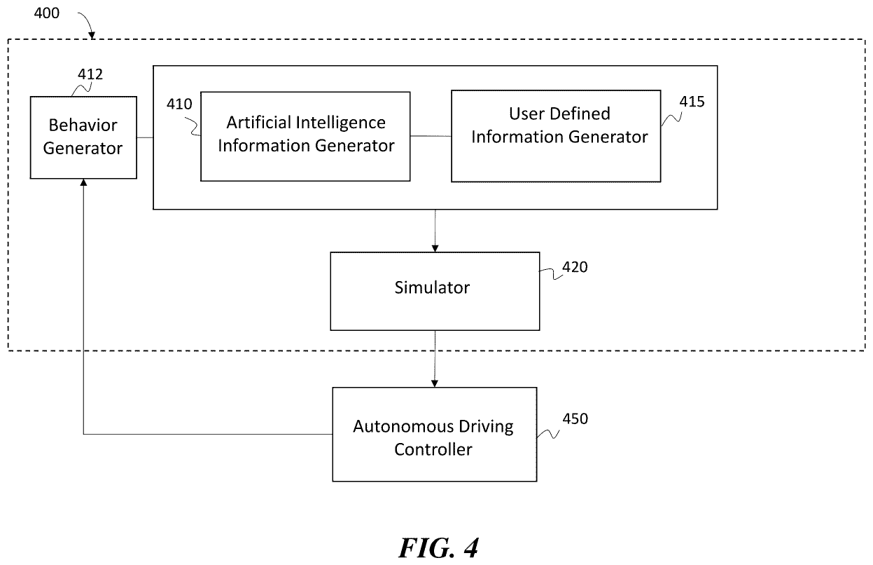

FIG. 4 shows another example of AI agent behavior generation system based on some embodiments of the disclosed technology.

In some embodiments of the disclosed technology, an AI agent behavior generation system 400 may include an artificial intelligence information generator 410, a simulator 420, and a user defined information generator 415. In some implementations, the generated trajectory of the NPC is provided to an autonomous driving controller 350 to control an autonomous vehicle (e.g., EGO).

In some embodiments of the disclosed technology, the artificial intelligence information generator 410 is in communication with a behavior generator 412 to obtain a normal distribution of an NPC (e.g., external vehicle/object/pedestrian). In one example, the artificial intelligence information generator 410 may include an artificial intelligence (AI) system configured to provide realistic behaviors of the NPC using an AI learning system.

In some embodiments of the disclosed technology, the user defined information generator 415 may provide second parameters that can be used in the simulator 420 to generate unrealistic behaviors of the NPC (e.g., external vehicle, object, or pedestrian) according to the second parameters. In this way, the user defined information generator 415 creates specific behaviors/trajectories that can be used along with behaviors/trajectories that are generated using the artificial intelligence information generator 410.

In some embodiments of the disclosed technology, the simulator 420 may generate a behavior of an NPC (e.g., external vehicle/object/pedestrian) based on one or more parameters provided by the artificial intelligence information generator 410 or based on one or more second parameters provided by the user defined information generator 415.

In some embodiments of the disclosed technology, the behavior generator 412 includes a plurality of states at a given time. In some implementations, each of the plurality of states corresponds to a certain behavior of an NPC (e.g., an external vehicle/object/pedestrian). In one example, the plurality of states includes a default behavior state corresponding to an initial state of the NPC. In one example, the plurality of states corresponds to a plurality of behaviors with behavior conditions and actions that can trigger a transition to a certain behavior. In one example, the behavior conditions can be used to define how a transition can be triggered, and the actions can trigger a transition to a certain behavior. In one example, the behavior generator 412 includes a final state of an NPC after it finishes all the transitions.

In some embodiments of the disclosed technology, the artificial intelligence information generator 410 may include an AI learning system to generate a behavior of an NPC that react to its surrounding environment using the AI learning system.

In some implementations, the artificial intelligence information generator 410 may include one or more parameters to determine the behavior of the NPC using the AI learning system.

In some embodiments of the disclosed technology, the user defined information generator 415 may provide one or more second parameters to allow an NPC to travel through a user defined trajectory.

In some implementations, the user defined information generator 415 may allow the simulator 420 to generate an unrealistic or variant behavior that is different from an AI expected behavior generated using the AI learning system based on the parameters in the artificial intelligence information generator 410.

In some implementations, the user defined information generator 415 may include one or more second parameters to determine an unrealistic behavior of the NPC based on the user defined trajectory.

In some implementations, the one or more second parameters include a transition trigger parameter to determine whether the simulator 420 uses the artificial intelligence information generator 410 or the user defined information generator 415. In one example, the simulator 420 may generate a behavior of an NPC using the user defined information generator 415 by switching from the artificial intelligence information generator 410 to the user defined information generator 415 based on the transition trigger parameter. In one example, the simulator 420 may generate a behavior of an NPC using the artificial intelligence information generator 410 by switching from the user defined information generator 415 to the artificial intelligence information generator 410 based on the transition trigger parameter.

In some implementations, the simulator 420 may simulate NPC behaviors and generate a future trajectory of the NPC based on trajectory information provided by the artificial intelligence information generator 410 or the user defined information generator 415.

In some implementations, the future trajectory of the object is provided to the autonomous driving controller 450 to control the autonomous vehicle based on the future trajectory of the object. In some implementations, the autonomous driving controller 450 provides feedback data associated with an actual behavior of the NPC to the behavior generator 412 to update the plurality of states in the behavior generator 412.

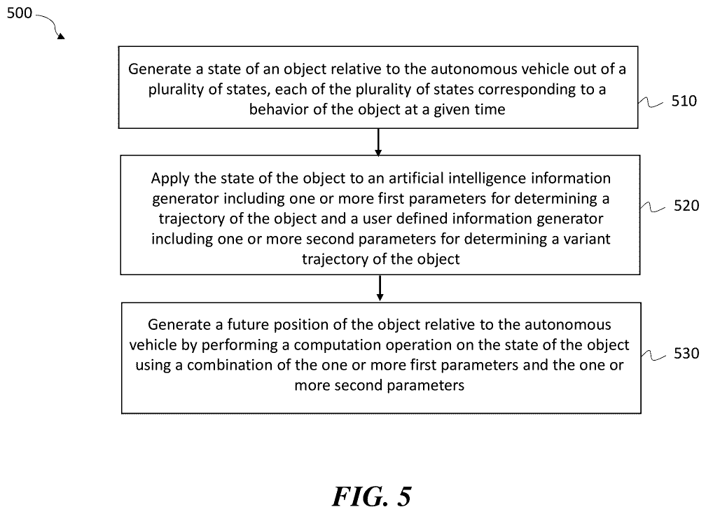

FIG. 5 shows a flowchart of an example of a trajectory generation method 500 for controlling an autonomous vehicle based on some embodiments of the disclosed technology.

In some embodiments, the trajectory generation method 500 includes, at 510, generating a state of an object relative to the autonomous vehicle, out of a plurality of states, each of the plurality of states corresponding to a behavior of the object at a given time, at 520, applying the state of the object to an artificial intelligence information generator including one or more first parameters for determining a trajectory of the object and a user defined information generator including one or more second parameters for determining a variant trajectory of the object, at 530, and at 530, generating a future position of the object relative to the autonomous vehicle by performing a computation operation on the state of the object using a combination of the one or more first parameters and the one or more second parameters.

In some embodiments, the one or more first parameters are determined based on data gathered from real life events, and each of the one or more second parameters is determined by applying a variance value to a corresponding normal parameter.

In some embodiments, the method further includes providing the future trajectory of the object to an autonomous driving controller to control the autonomous vehicle based on the future trajectory of the object.

In some embodiments, the method further includes receiving, from the autonomous driving controller, feedback data associated with an actual behavior of the object to update the plurality of states.

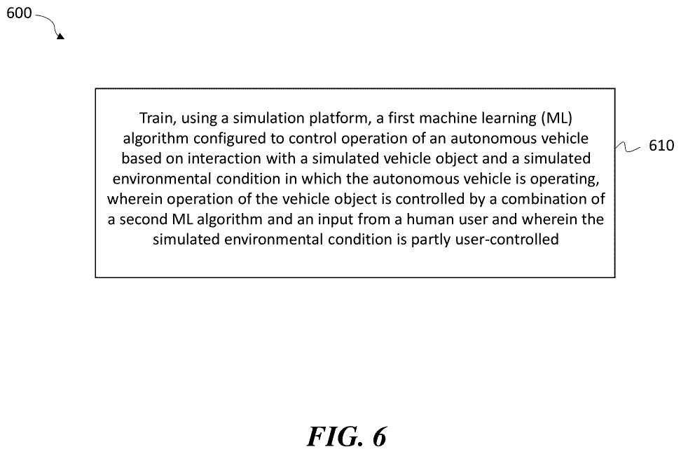

FIG. 6 shows a flowchart of another example of a trajectory generation method 600 for controlling an autonomous vehicle based on some embodiments of the disclosed technology.

In some embodiments, the trajectory generation method 600 includes, at 610, training, using a simulation platform, a first machine learning (ML) algorithm configured to control operation of an autonomous vehicle based on interaction with a simulated vehicle object and a simulated environmental condition in which the autonomous vehicle is operating, wherein operation of the vehicle object is controlled by a combination of a second ML algorithm and an input from a human user and wherein the simulated environmental condition is partly user-controlled.

In some embodiments, the trajectory generation method 600 further includes operating the autonomous vehicle using the first ML algorithm for road driving; collecting driving data from the road driving; and using the driving data collected from the road driving to train the second ML algorithm.

In some embodiments, the simulation platform simulates simultaneous interaction with multiple vehicle objects, each of which is controlled by a respective controller that is trained by a respective ML model.

In some embodiments, the second ML algorithm is configured to control a trajectory of the vehicle object.

In some embodiments, the input from the human user is configured to simulate unexpected behavior of the vehicle object.

Therefore, various implementations of features of the disclosed technology can be made based on the above disclosure, including the examples listed below.

Example 1. A trajectory generation system for controlling an autonomous vehicle, comprising: a behavior generator including a plurality of states of an object relative to the autonomous vehicle, each of the plurality of states of the object corresponding to a behavior of the object at a given time, the behavior generator configured to generate one of the plurality of states; an artificial intelligence information generator including one or more first parameters for determining a trajectory of the object and in communication with the behavior generator to obtain the one of the plurality of states from the behavior generator and to provide the one or more first parameters based on the one of the plurality of states; a user defined information generator including one or more second parameters for determining a variant trajectory of the object and in communication with the behavior generator to obtain the one of the plurality of states from the behavior generator and to provide the one or more second parameters based on the one of the plurality of states; and a simulator in communication with the artificial intelligence information generator and the user defined information generator and configured to generate a future position of the object by performing a computation operation on the one of the plurality of states using a combination of the one or more first parameters and the one or more second parameters.

Example 2. The system of example 1, wherein the future position of the object is provided to an autonomous driving controller to control the autonomous vehicle based on the future position of the object.

Example 3. The system of example 2, wherein the autonomous driving controller provides feedback data associated with an actual behavior of the object to the behavior generator to update the plurality of states in the behavior generator.

Example 4. The system of example 1, wherein the behavior generator includes a finite state machine configured to be in one of the plurality of states at a given time.

Example 5. The system of example 4, wherein the finite state machine includes a plurality of behavior modules corresponding to the plurality of states, respectively, to transition between different behavior modules upon occurrence a predetermined event.

Example 6. The system of example 5, wherein one of the plurality of behavior modules provides the one of the plurality of states to at least one of the artificial intelligence information generator or the user defined information generator.

Example 7. The system of example 1, wherein the one or more first parameters are determined based on data gathered from real life events.

Example 8. The system of example 7, wherein each of the one or more second parameters is determined by applying a variance value to a corresponding first parameter.

Example 9. The system of example 1, wherein the simulator generates the future position of the object using the user defined information generator upon determination that the one of the plurality of states is associated with a predetermined behavior.

Example 10. The system of example 9, wherein the simulator generates the future position of the object using the artificial intelligence information generator upon determination that the one of the plurality of states is not associated with the predetermined behavior.

Example 11. The system of example 1, wherein the one or more second parameters include a transition trigger parameter to determine whether the simulator uses the artificial intelligence information generator or the user defined information generator.

Example 12. The system of example 11, wherein the simulator generates the future position of the object using the user defined information generator by switching from the artificial intelligence information generator to the user defined information generator based on the transition trigger parameter.

Example 13. The system of example 11, wherein the simulator generates the future position of the object using the artificial intelligence information generator by switching from the user defined information generator to the artificial intelligence information generator based on the transition trigger parameter.

Example 14. The system of example 1, wherein the object is a vehicle or a pedestrian.

Example 15. A trajectory generation method for controlling an autonomous vehicle, comprising: generating a state of an object relative to the autonomous vehicle, out of a plurality of states, each of the plurality of states corresponding to a behavior of the object at a given time; applying the state of the object to an artificial intelligence information generator including one or more first parameters for determining a trajectory of the object and a user defined information generator including one or more second parameters for determining a variant trajectory of the object; and generating a future position of the object relative to the autonomous vehicle by performing a computation operation on the state of the object using a combination of the one or more first parameters and the one or more second parameters.

Example 16. The method of example 15, further comprising determining whether to use the one or more first parameters or the one or more second parameters based on whether the state of the object is associated with a predetermined behavior.

Example 17. The method of example 15, wherein the one or more first parameters are determined based on data gathered from real life events, wherein each of the one or more second parameters is determined by applying a variance value to a corresponding first parameter.

Example 18. The method of example 15, wherein the one or more first parameters are determined based on data gathered from real life events, and each of the one or more second parameters is determined by applying a variance value to a corresponding normal parameter.

Example 19. The method of example 15, further comprising providing the future position of the object to an autonomous driving controller to control the autonomous vehicle based on the future position of the object.

Example 20. The method of example 19, further comprising receiving, from the autonomous driving controller, feedback data associated with an actual behavior of the object to update the plurality of states.

Example 21. A method of operating an autonomous vehicle, comprising: training, using a simulation platform, a first machine learning (ML) algorithm configured to control operation of an autonomous vehicle based on interaction with a simulated vehicle object and a simulated environmental condition in which the autonomous vehicle is operating; wherein operation of the vehicle object is controlled by a combination of a second ML algorithm and an input from a human user and wherein the simulated environmental condition is partly user-controlled.

Example 22. The method of example 21, further including: operating the autonomous vehicle using the first ML algorithm for road driving; collecting driving data from the road driving; and using the driving data collected from the road driving to train the second ML algorithm.

Example 23. The method of example 21, wherein the simulation platform simulates simultaneous interaction with multiple vehicle objects, each of which is controlled by a respective controller that is trained by a respective ML model.

Example 24. The method of example 21, wherein the second ML algorithm is configured to control a trajectory of the vehicle object.

Example 25. The method of example 21, wherein the input from the human user is configured to simulate unexpected behavior of the vehicle object.

Example 26. The method of example 21, wherein the simulated environmental condition comprises ambient light, instantaneous appearance of objects, wet road conditions, etc.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A trajectory generation system for controlling an autonomous vehicle, comprising:
a behavior generator including a plurality of states of an object relative to the autonomous vehicle, each of the plurality of states of the object corresponding to a behavior of the object at a given time, the behavior generator configured to generate one of the plurality of states;
an artificial intelligence information generator including one or more first parameters for determining a trajectory of the object and in communication with the behavior generator to obtain the one of the plurality of states from the behavior generator and to provide the one or more first parameters based on the one of the plurality of states;
a user defined information generator including one or more second parameters for determining a variant trajectory of the object and in communication with the behavior generator to obtain the one of the plurality of states from the behavior generator and to provide the one or more second parameters based on the one of the plurality of states; and
a simulator in communication with the artificial intelligence information generator and the user defined information generator and configured to generate a future position of the object by performing a computation operation on the one of the plurality of states using a combination of the one or more first parameters and the one or more second parameters.

2. The system of claim 1, wherein the future position of the object is provided to an autonomous driving controller to control the autonomous vehicle based on the future position of the object.

3. The system of claim 2, wherein the autonomous driving controller provides feedback data associated with an actual behavior of the object to the behavior generator to update the plurality of states in the behavior generator.

4. The system of claim 1, wherein the behavior generator includes a finite state machine configured to be in one of the plurality of states at a given time.

5. The system of claim 4, wherein the finite state machine includes a plurality of behavior modules corresponding to the plurality of states, respectively, to transition between different behavior modules upon occurrence a predetermined event.

6. The system of claim 5, wherein one of the plurality of behavior modules provides the one of the plurality of states to at least one of the artificial intelligence information generator or the user defined information generator.

7. The system of claim 1, wherein the one or more first parameters are determined based on data gathered from real life events.

8. The system of claim 7, wherein each of the one or more second parameters is determined by applying a variance value to a corresponding first parameter.

9. The system of claim 1, wherein the one or more second parameters include a transition trigger parameter to determine whether the simulator uses the artificial intelligence information generator or the user defined information generator.

10. The system of claim 9, wherein the simulator generates the future position of the object using the user defined information generator by switching from the artificial intelligence information generator to the user defined information generator based on the transition trigger parameter.

11. The system of claim 9, wherein the simulator generates the future position of the object using the artificial intelligence information generator by switching from the user defined information generator to the artificial intelligence information generator based on the transition trigger parameter.

12. The system of claim 1, wherein the object is a vehicle or a pedestrian.

13. A method of operating an autonomous vehicle, comprising:
training, using a simulation platform, a first machine learning (ML) algorithm configured to control operation of an autonomous vehicle based on interaction with a simulated vehicle object and a simulated environmental condition in which the autonomous vehicle is operating;
wherein operation of the vehicle object is controlled by a combination of a second ML algorithm and an input from a human user and wherein the simulated environmental condition is partly user-controlled.

14. The method of claim 13, further including: operating the autonomous vehicle using the first ML algorithm for road driving; collecting driving data from the road driving; and using the driving data collected from the road driving to train the second ML algorithm.

15. The method of claim 13, wherein the simulation platform simulates simultaneous interaction with multiple vehicle objects, each of which is controlled by a respective controller that is trained by a respective ML model.

16. The method of claim 13, wherein the second ML algorithm is configured to control a trajectory of the vehicle object.

17. The method of claim 13, wherein the input from the human user is configured to simulate unexpected behavior of the vehicle object.

18. A trajectory generation method for controlling an autonomous vehicle, comprising:
generating a state of an object relative to the autonomous vehicle, out of a plurality of states, each of the plurality of states corresponding to a behavior of the object at a given time;
applying the state of the object to an artificial intelligence information generator including one or more first parameters for determining a trajectory of the object and a user defined information generator including one or more second parameters for determining a variant trajectory of the object; and
generating a future position of the object relative to the autonomous vehicle by performing a computation operation on the state of the object using a combination of the one or more first parameters and the one or more second parameters,
wherein the one or more first parameters are determined based on data gathered from real life events, wherein each of the one or more second parameters is determined by applying a variance value to a corresponding first parameter.

19. The method of claim 18, further comprising providing the future position of the object to an autonomous driving controller to control the autonomous vehicle based on the future position of the object.

20. The method of claim 19, further comprising receiving, from the autonomous driving controller, feedback data associated with an actual behavior of the object to update the plurality of states.
